(19) United States
(12) Patent Application Publication
(10) Pub. No.: US 2023/0072737 A1
(43) Pub. Date: Mar. 9, 2023

(54) METHODS, SYSTEMS, APPARATUSES, AND DEVICES FOR PREVENTING FOGGING IN A HEAD WORN APPARATUS

(71) Applicant: Jose Morales, Beaverton, OR (US)

(72) Inventor: Jose Morales, Beaverton, OR (US)

(21) Appl. No.: 17/569,812

(22) Filed: Jan. 6, 2022

Related U.S. Application Data
(60) Provisional application No. 63/241,378, filed on Sep. 7, 2021.

(51) Int. Cl. A42B 3/28; G02B 27/01; A42B 3/04

(52) U.S. Cl. CPC A42B 3/286; G02B 27/0176; A42B 3/0433; G02B 2027/0192

(57) ABSTRACT

Disclosed herein is an apparatus for preventing fogging in a head worn apparatus, in accordance with some embodiments. Further, the head worn apparatus covers a portion of a head of a user. Further, the apparatus comprises an elongated body, an attachment mechanism, and a fan assembly. Further, the elongated body extends from a first end of a first portion to a second end of a second portion. Further, the elongated body is curved around an axis perpendicular to the elongated body making the first portion substantially perpendicular to the second portion. Further, the elongated body tapers from the first end towards the second end. Further, the attachment mechanism is configured to be coupled with a portion of the head worn apparatus. Further, the at least one fan assembly is configured for circulating airflow in the head worn apparatus.

### FIELD OF THE INVENTION

Generally, the present disclosure relates to the field of ventilation. More specifically, the present disclosure relates to methods, systems, apparatuses, and devices for preventing fogging in a head worn apparatus.

### BACKGROUND OF THE INVENTION

Virtual Reality is an emerging technology slowly becoming adopted by the world that allows individuals to experience and become immersed in a world that is not their current surrounding environment. Virtual Reality headsets are worn on the head and cover the eyes and sometimes the ears as well to give a complete surrounding virtual environment. Many Virtual Reality headsets are used to play video games, watch videos, and complete at home workouts. Due to the Virtual Reality headset sealing around the eyes and containing a display screen within the headset, heat and moisture buildup is inevitable. Some Virtual Reality headsets are equipped with fans for the electronics to keep them at a cool stable temperature, however if the Virtual Reality headset it being used for a workout, then the fans within the Virtual Reality headsets are not designed to handle the amount of heat and moisture developing within the seal between the Virtual reality headset and the user. This causes the lens within the Virtual Reality headsets to fog up blurring the image seen by the user and interfering with the Virtual Reality headset experience. The only current solution is to either lower the intensity of the workout being performed or take the Virtual Reality headset off to wipe of the lenses within the headset. Unfortunately, both of these solutions either fully interrupt the workout being completed or do not allow the user to exert energy above a certain level.

Therefore, there is a need for improved methods, systems, apparatuses, and devices for preventing fogging in a head worn apparatus that may overcome one or more of the above-mentioned problems and/or limitations.

### SUMMARY OF THE INVENTION

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

Disclosed herein is an apparatus for preventing fogging in a head worn apparatus, in accordance with some embodiments. Further, the head worn apparatus covers at least one portion of a head of a user. Further, the apparatus may include an elongated body, at least one attachment mechanism, and at least one fan assembly. Further, the elongated body may include a first portion and a second portion. Further, the elongated body extends from a first end of the first portion to a second end of the second portion. Further, the elongated body may be curved around an axis perpendicular to the elongated body making the first portion substantially perpendicular to the second portion. Further, the elongated body may include an interior space and a first opening and a second opening leading into the interior space. Further, the interior space extends between the first end and the second end. Further, a cross sectional area of the first opening disposed on the first portion corresponds to a cross sectional area of the interior space at the first end and a cross sectional area of the second opening disposed on the second portion corresponds to the cross sectional area of the interior space at the second end. Further, the elongated body tapers from the first end towards the second end reducing the cross sectional area of the interior space from the first end towards the second end. Further, the at least one attachment mechanism may be disposed on the second portion of the elongated body proximal to the second opening. Further, the at least one attachment mechanism may be configured to be coupled with at least one portion of the head worn apparatus for securing the apparatus to the head worn apparatus. Further, the interior space may be fluidly coupled with the head worn apparatus through the second opening based on the securing of the apparatus to the head worn apparatus. Further, the at least one fan assembly may be disposed in the interior cavity. Further, the at least one fan assembly may be coupled with the first opening. Further, the at least one fan assembly may be electrically powered. Further, the at least one fan assembly may be configured for circulating airflow in the head worn apparatus. Further, the preventing of the fogging in the head worn apparatus may be based on the circulating of the airflow.

Further disclosed herein is an apparatus for preventing fogging in a head worn apparatus, in accordance with some embodiments. Further, the head worn apparatus covers at least one portion of a head of a user. Further, the apparatus may include an elongated body, at least one attachment mechanism, at least one fan assembly, and a cover. Further, the elongated body may include a first portion and a second portion. Further, the elongated body extends from a first end of the first portion to a second end of the second portion. Further, the elongated body may be curved around an axis perpendicular to the elongated body making the first portion substantially perpendicular to the second portion. Further, the elongated body may include an interior space and a first opening and a second opening leading into the interior space. Further, the interior space extends between the first end and the second end. Further, a cross sectional area of the first opening disposed on the first portion corresponds to a cross sectional area of the interior space at the first end and a cross sectional area of the second opening disposed on the second portion corresponds to the cross sectional area of the interior space at the second end. Further, the elongated body tapers from the first end towards the second end reducing the cross sectional area of the interior space from the first end towards the second end. Further, the at least one attachment mechanism may be disposed on the second portion of the elongated body proximal to the second opening. Further, the at least one attachment mechanism may be configured to be coupled with at least one portion of the head worn apparatus for securing the apparatus to the head worn apparatus. Further, the interior space may be fluidly coupled with the head worn apparatus through the second opening based on the securing of the apparatus to the head worn apparatus. Further, the at least one fan assembly may be disposed in the interior cavity. Further, the at least one fan assembly may be coupled with the first opening. Further, the at least one fan assembly may be electrically powered. Further, the at least one fan assembly may be configured for circulating airflow in the head worn apparatus. Further, the preventing of the fogging in the head worn apparatus may be based on the circulating of the airflow. Further, the cover may be coupled with the first opening. Further, the cover may include at least one opening of at least one size. Further, the cover may be configured for preventing at least one contaminant of the at least one size from entering the interior cavity through the first opening.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is a side perspective of an apparatus for preventing fogging in a head worn apparatus, in accordance with some embodiments.

FIG. 2 is a side perspective of the apparatus with the cover for preventing the fogging in the head worn apparatus, in accordance with some embodiments.

FIG. 3 is a side perspective of the apparatus with the cover for preventing the fogging in the head worn apparatus, in accordance with some embodiments.

FIG. 4 is a side perspective of the apparatus with the cover for preventing the fogging in the head worn apparatus, in accordance with some embodiments.

FIG. 5 is a side perspective of the apparatus with the cover for preventing the fogging in the head worn apparatus, in accordance with some embodiments.

FIG. 6 is a side perspective of the apparatus with the cover for preventing the fogging in the head worn apparatus, in accordance with some embodiments.

FIG. 7 is a side perspective of the apparatus with the cover for preventing the fogging in the head worn apparatus, in accordance with some embodiments.

FIG. 8 is a side perspective of the apparatus with the cover for preventing the fogging in the head worn apparatus, in accordance with some embodiments.

FIG. 9 is a side perspective of the apparatus with the cover for preventing the fogging in the head worn apparatus, in accordance with some embodiments.

FIG. 10 is a side perspective of the apparatus with the cover for preventing the fogging in the head worn apparatus, in accordance with some embodiments.

FIG. 11 is a side perspective of the apparatus with the cover for preventing the fogging in the head worn apparatus, in accordance with some embodiments.

FIG. 12 is a front view of the apparatus with the cover for preventing the fogging in the head worn apparatus, in accordance with some embodiments.

FIG. 13 is a rear view of the apparatus with the cover for preventing the fogging in the head worn apparatus, in accordance with some embodiments.

FIG. 14 is a right-side view of the apparatus with the cover for preventing the fogging in the head worn apparatus, in accordance with some embodiments.

FIG. 15 is a left-side view of the apparatus with the cover for preventing the fogging in the head worn apparatus, in accordance with some embodiments.

FIG. 16 is a top view of the apparatus with the cover for preventing the fogging in the head worn apparatus, in accordance with some embodiments.

FIG. 17 is a bottom view of the apparatus with the cover for preventing the fogging in the head worn apparatus, in accordance with some embodiments.

FIG. 18 is a side perspective of an apparatus for preventing fogging in a head worn apparatus, in accordance with some embodiments.

FIG. 19 is an illustration of an online platform consistent with various embodiments of the present disclosure.

FIG. 20 is a block diagram of a computing device for implementing the methods disclosed herein, in accordance with some embodiments.

### DETAIL DESCRIPTIONS OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of methods, systems, apparatuses, and devices for preventing fogging in a head worn apparatus, embodiments of the present disclosure are not limited to use only in this context.

In general, the method disclosed herein may be performed by one or more computing devices. For example, in some embodiments, the method may be performed by a server computer in communication with one or more client devices over a communication network such as, for example, the Internet. In some other embodiments, the method may be performed by one or more of at least one server computer, at least one client device, at least one network device, at least one sensor and at least one actuator. Examples of the one or more client devices and/or the server computer may include, a desktop computer, a laptop computer, a tablet computer, a personal digital assistant, a portable electronic device, a wearable computer, a smart phone, an Internet of Things (IoT) device, a smart electrical appliance, a video game console, a rack server, a super-computer, a mainframe computer, mini-computer, micro-computer, a storage server, an application server (e.g. a mail server, a web server, a real-time communication server, an FTP server, a virtual server, a proxy server, a DNS server etc.), a quantum computer, and so on. Further, one or more client devices and/or the server computer may be configured for executing a software application such as, for example, but not limited to, an operating system (e.g. Windows, Mac OS, Unix, Linux, Android, etc.) in order to provide a user interface (e.g. GUI, touch-screen based interface, voice based interface, gesture based interface etc.) for use by the one or more users and/or a network interface for communicating with other devices over a communication network. Accordingly, the server computer may include a processing device configured for performing data processing tasks such as, for example, but not limited to, analyzing, identifying, determining, generating, transforming, calculating, computing, compressing, decompressing, encrypting, decrypting, scrambling, splitting, merging, interpolating, extrapolating, redacting, anonymizing, encoding and decoding. Further, the server computer may include a communication device configured for communicating with one or more external devices. The one or more external devices may include, for example, but are not limited to, a client device, a third party database, public database, a private database and so on. Further, the communication device may be configured for communicating with the one or more external devices over one or more communication channels. Further, the one or more communication channels may include a wireless communication channel and/or a wired communication channel. Accordingly, the communication device may be configured for performing one or more of transmitting and receiving of information in electronic form. Further, the server computer may include a storage device configured for performing data storage and/or data retrieval operations. In general, the storage device may be configured for providing reliable storage of digital information. Accordingly, in some embodiments, the storage device may be based on technologies such as, but not limited to, data compression, data backup, data redundancy, deduplication, error correction, data finger-printing, role based access control, and so on.

Further, one or more steps of the method disclosed herein may be initiated, maintained, controlled and/or terminated based on a control input received from one or more devices operated by one or more users such as, for example, but not limited to, an end user, an admin, a service provider, a service consumer, an agent, a broker and a representative thereof. Further, the user as defined herein may refer to a human, an animal or an artificially intelligent being in any state of existence, unless stated otherwise, elsewhere in the present disclosure. Further, in some embodiments, the one or more users may be required to successfully perform authentication in order for the control input to be effective. In general, a user of the one or more users may perform authentication based on the possession of a secret human readable secret data (e.g. username, password, passphrase, PIN, secret question, secret answer etc.) and/or possession of a machine readable secret data (e.g. encryption key, decryption key, bar codes, etc.) and/or or possession of one or more embodied characteristics unique to the user (e.g. biometric variables such as, but not limited to, fingerprint, palm-print, voice characteristics, behavioral characteristics, facial features, iris pattern, heart rate variability, evoked potentials, brain waves, and so on) and/or possession of a unique device (e.g. a device with a unique physical and/or chemical and/or biological characteristic, a hardware device with a unique serial number, a network device with a unique IP/MAC address, a telephone with a unique phone number, a smartcard with an authentication token stored thereupon, etc.). Accordingly, the one or more steps of the method may include communicating (e.g. transmitting and/or receiving) with one or more sensor devices and/or one or more actuators in order to perform authentication. For example, the one or more steps may include receiving, using the communication device, the secret human readable data from an input device such as, for example, a keyboard, a keypad, a touch-screen, a microphone, a camera and so on. Likewise, the one or more steps may include receiving, using the communication device, the one or more embodied characteristics from one or more biometric sensors.

Further, one or more steps of the method may be automatically initiated, maintained and/or terminated based on one or more predefined conditions. In an instance, the one or more predefined conditions may be based on one or more contextual variables. In general, the one or more contextual variables may represent a condition relevant to the performance of the one or more steps of the method. The one or more contextual variables may include, for example, but are not limited to, location, time, identity of a user associated with a device (e.g. the server computer, a client device etc.) corresponding to the performance of the one or more steps, environmental variables (e.g. temperature, humidity, pressure, wind speed, lighting, sound, etc.) associated with a device corresponding to the performance of the one or more steps, physical state and/or physiological state and/or psychological state of the user, physical state (e.g. motion, direction of motion, orientation, speed, velocity, acceleration, trajectory, etc.) of the device corresponding to the performance of the one or more steps and/or semantic content of data associated with the one or more users. Accordingly, the one or more steps may include communicating with one or more sensors and/or one or more actuators associated with the one or more contextual variables. For example, the one or more sensors may include, but are not limited to, a timing device (e.g. a real-time clock), a location sensor (e.g. a GPS receiver, a GLONASS receiver, an indoor location sensor etc.), a biometric sensor (e.g. a fingerprint sensor), an environmental variable sensor (e.g. temperature sensor, humidity sensor, pressure sensor, etc.) and a device state sensor (e.g. a power sensor, a voltage/current sensor, a switch-state sensor, a usage sensor, etc. associated with the device corresponding to performance of the or more steps).

Further, the one or more steps of the method may be performed one or more number of times. Additionally, the one or more steps may be performed in any order other than as exemplarily disclosed herein, unless explicitly stated otherwise, elsewhere in the present disclosure. Further, two or more steps of the one or more steps may, in some embodiments, be simultaneously performed, at least in part. Further, in some embodiments, there may be one or more time gaps between performance of any two steps of the one or more steps.

Further, in some embodiments, the one or more predefined conditions may be specified by the one or more users. Accordingly, the one or more steps may include receiving, using the communication device, the one or more predefined conditions from one or more and devices operated by the one or more users. Further, the one or more predefined conditions may be stored in the storage device. Alternatively, and/or additionally, in some embodiments, the one or more predefined conditions may be automatically determined, using the processing device, based on historical data corresponding to performance of the one or more steps. For example, the historical data may be collected, using the storage device, from a plurality of instances of performance of the method. Such historical data may include performance actions (e.g. initiating, maintaining, interrupting, terminating, etc.) of the one or more steps and/or the one or more contextual variables associated therewith. Further, machine learning may be performed on the historical data in order to determine the one or more predefined conditions. For instance, machine learning on the historical data may determine a correlation between one or more contextual variables and performance of the one or more steps of the method. Accordingly, the one or more predefined conditions may be generated, using the processing device, based on the correlation.

Further, one or more steps of the method may be performed at one or more spatial locations. For instance, the method may be performed by a plurality of devices interconnected through a communication network. Accordingly, in an example, one or more steps of the method may be performed by a server computer. Similarly, one or more steps of the method may be performed by a client computer. Likewise, one or more steps of the method may be performed by an intermediate entity such as, for example, a proxy server. For instance, one or more steps of the method may be performed in a distributed fashion across the plurality of devices in order to meet one or more objectives. For example, one objective may be to provide load balancing between two or more devices. Another objective may be to restrict a location of one or more of an input data, an output data and any intermediate data therebetween corresponding to one or more steps of the method. For example, in a client-server environment, sensitive data corresponding to a user may not be allowed to be transmitted to the server computer. Accordingly, one or more steps of the method operating on the sensitive data and/or a derivative thereof may be performed at the client device.

Overview:

The present disclosure describes methods, systems, apparatuses, and devices for preventing fogging in a head worn apparatus. Further, the present disclosure describes a Virtual Reality headset fan to help with limiting lens fog. Further, the disclosed apparatus seeks to provide users with an air duct and fan system to circulate cool and dry air into the Virtual Reality headset. In order to accomplish this, the disclosed apparatus comprises an air duct that had two open ends allowing air to move from outside and into the Virtual Reality headset. Further, the headset attachment allows the air duct to attach universally to any standard Virtual Reality headset. Additionally, the fan is designed to pull air from outside the Virtual Reality headset through the air duct and into the Virtual Reality headset, powered by an external battery pack. Thus, the the disclosed apparatus is an air duct and fan system attachment to a Virtual Reality headset to circulate cool and dry air within the headset to avoid lens fog during active use of the Virtual Reality headset.

Further, the disclosed apparatus provides users with an air duct and fan system, to help eliminate heat and moisture buildup within a Virtual Reality headset. The disclosed apparatus intends to provide users with a device that can circulate air within a Virtual Reality headset to avoid the lenses within from fogging up during active use. In order to accomplish that, a preferred embodiment of the disclosed apparatus comprises an air duct, a headset attachment, and a fan. Further, the fan is used to push cooler, less humid air into the Virtual Reality headset, limiting lens fog. Thus, the disclosed apparatus is an air duct and fan system attachment to a Virtual Reality headset to circulate cool and dry air within the headset to avoid lens fog during active use of the Virtual Reality headset.

The disclosed apparatus relates generally to an air duct and a fan system for virtual reality goggles or headsets. More specifically, the disclosed apparatus is a device that helps to circulate air within a Virtual Reality headset to avoid moisture and heat buildup, preventing lens fog.

Further, the disclosed apparatus is a Virtual Reality headset fan that pushes air into the Virtual Reality headset. An objective of the disclosed apparatus is to provide users with an air duct and fan system to circulate air within the seal between the Virtual Reality headset and the face of the user. The disclosed apparatus intends to provide users with a device that can eliminate lens fog within a Virtual Reality headset, improving user experience while actively using the headset. To accomplish this the disclosed apparatus comprises an air duct, a headset attachment, and a fan. Many of these components allow for cool dry air to move into the Virtual Reality headset, increasing the duration of the Virtual Reality headset use. The headset attachment attaches to the back of any standards Virtual Reality headset. The air duct is the placed on the front side of the air duct with the fan placed at the top square section created by the two components. The fan slides into the section where it is secured by a plurality of screws that holds the various components together. Thus, the disclosed apparatus is an air duct and fan system attachment to a Virtual Reality headset to circulate cool and dry air within the headset to avoid lens fog during active use of the Virtual Reality headset.

The disclosed apparatus can move air through the air duct. The air duct is made of a plastic lightweight material, with a unique shape. The air duct is designed with a lightweight material to create a lighter equipment for the user to use during their Virtual Reality headset fitness workout. The air duct is designed with a curved hollow shape that has a J-shape. The hollow air duct cross section starts with a square shape at the top of the air duct and transitions to a semicircular shape at the opposite end. In its preferred embodiment the air duct has a plurality of duct screw holes. The plurality of duct screw holes is located on the top front inner side of the air duct. The plurality of duct screw holes is made of a similar lightweight plastic material and has a square shape with vertical cylindrical cutouts with a threaded inner wall. This design allows for the air duct to be properly secured to the disclosed apparatus. It should be further noted that the air duct can be created in many various shapes and sizes and a plurality of duct screw holes can be positioned in various areas while still staying within the scope of the disclosed apparatus.

The headset attachment connects to the back of the air duct and secures the disclosed apparatus to the back of a Virtual Reality headset. The headset attachment is designed as a curved elongated plate that matches the curve of the rear side of the air duct. In its preferred embodiment the headset attachment is made of a similar lightweight plastic material and comprises a plurality of headset screw holes and a plurality of fasteners. The plurality of headset screw holes is designed with a similar shape as the plurality of duct screw holes with vertical cylindrical cutouts, positioned on the top front side of the headset attachment. This design allows for four mounting areas for the fan when the air duct and the headset attachment are lined up together in the proper arrangement. The plurality of fasteners is positioned on the rear side of the headset attachment. The plurality of fasteners can be designed as clips, adhesives, screws or any other fastening mechanism that holds the disclosed apparatus to the headset. The plurality of fasteners is designed to ensure the disclosed apparatus can stay secured and not move while attached to a Virtual Reality headset throughout a fitness workout.

The fan connects with the air duct and the headset attachment via the plurality of duct screw holes and the plurality of headset screw holes respectively. The fan is designed with a lightweight plastic material and is USB powered. In its preferred embodiment the fan comprises a cover, a plurality of fan screw holes, a power port, and a plurality of screws. Further, the cover is designed as a flat square component with quarter ring cutouts that is positioned at the top of the fan. This design allows for air to be pulled into disclosed apparatus while ensuring large particles that could potentially clog the air duct or fan cannot enter the disclosed apparatus. Along the corners of the fan is the plurality of fan screw holes that are designed as vertical cylindrical holes with a threaded inner wall. The plurality of fan screw holes is made to line up concentrically with the plurality of duct screw holes and the plurality of headset screw holes. This allows the plurality of screws to screw into the plurality of fan screw holes, plurality of duct screw holes, and the plurality of headset screw holes, securing the air duct, headset attachment and fan together. Additionally, the disclosed apparatus, comprises a power port positioned within the fan component. The power port allows the fan component to connect with an external battery pack or power bank. This design allows the fan to receive the necessary power to circulate the air within the disclosed apparatus, thus eliminating lens fog. With all the components working in tandem with each other it can be seen that the disclosed apparatus is an air duct and fan system attachment to a Virtual Reality headset to circulate cool and dry air within the headset to avoid lens fog during active use of the Virtual Reality headset.

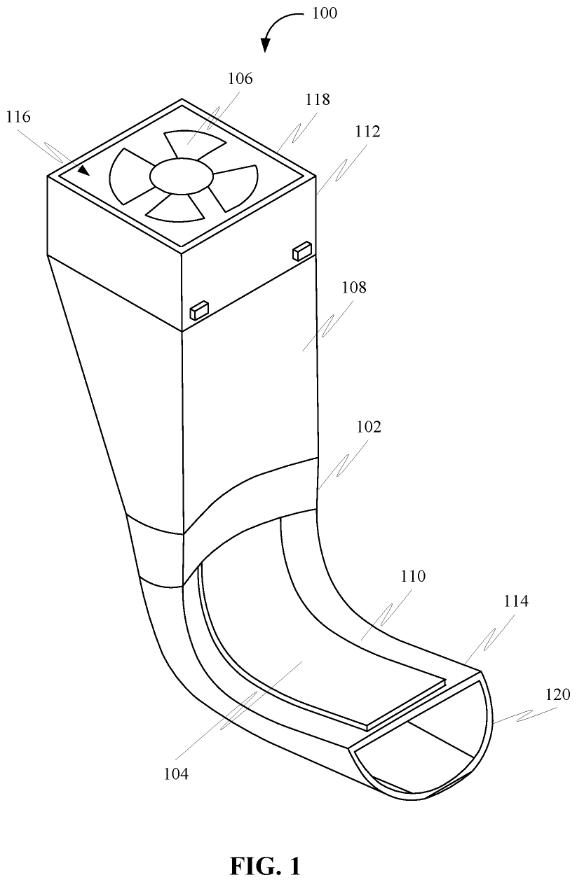

FIG. 1 is a side perspective of an apparatus 100 for preventing fogging in a head worn apparatus, in accordance with some embodiments. Further, the head worn apparatus covers at least one portion of a head of a user. Further, the head worn apparatus may include a headset, a VR headset, a helmet, etc. Further, the apparatus 100 may include an elongated body 102, at least one attachment mechanism 104, and at least one fan assembly 106. Further, the elongated body 102 may include a first portion 108 and a second portion 110. Further, the elongated body 102 extends from a first end 112 of the first portion 108 to a second end 114 of the second portion 110. Further, the elongated body 102 may be curved around an axis perpendicular to the elongated body 102 making the first portion 108 substantially perpendicular to the second portion 110. Further, the elongated body 102 may include an interior space 116 and a first opening 118 and a second opening 120 leading into the interior space 116. Further, the interior space 116 extends between the first end 112 and the second end 114. Further, a cross sectional area of the first opening 118 disposed on the first portion 108 corresponds to a cross sectional area of the interior space 116 at the first end 112 and a cross sectional area of the second opening 120 disposed on the second portion 110 corresponds to the cross sectional area of the interior space 116 at the second end 114. Further, the elongated body 102 tapers from the first end 112 towards the second end 114 reducing the cross sectional area of the interior space 116 from the first end 112 towards the second end 114. Further, the at least one attachment mechanism 104 may be disposed on the second portion 110 of the elongated body 102 proximal to the second opening 120. Further, the at least one attachment mechanism 104 may be configured to be coupled with at least one portion of the head worn apparatus for securing the apparatus 100 to the head worn apparatus. Further, the interior space 116 may be fluidly coupled with the head worn apparatus through the second opening 120 based on the securing of the apparatus 100 to the head worn apparatus. Further, the at least one fan assembly 106 may be disposed in the interior cavity. Further, the at least one fan assembly 106 may be coupled with the first opening 118. Further, the at least one fan assembly 106 may be electrically powered. Further, the at least one fan assembly 106 may be configured for circulating airflow in the head worn apparatus. Further, the preventing of the fogging in the head worn apparatus may be based on the circulating of the airflow.

Further, in some embodiments, the at least one fan assembly 106 may be configured for drawing the airflow into the interior space 116 through the first opening 118 and expelling the airflow to the head worn apparatus through the second opening 120. Further, the circulating may be based on the drawing of the airflow through the first opening 118 and the expelling of the airflow through the second opening 120.

Further, in an embodiment, the elongated body 102 may be configured for accelerating the airflow in the interior space 116 based on the reducing of the cross sectional area of the interior space 116 from the first end 112 towards the second end 114. Further, the circulating may be further based on the accelerating of the airflow.

Further, in some embodiments, the at least one fan assembly 106 may be configured for drawing the airflow into the interior space 116 from the head worn apparatus through the second opening 120 and expelling the airflow through the first opening 118. Further, the circulating may be based on the drawing of the airflow through the second opening 120 and the expelling of the airflow through the first opening 118.

Further, in an embodiment, the elongated body 102 may be configured for decelerating the airflow in the interior space 116 based on the reducing of the cross sectional area of the interior space 116 from the first end 112 towards the second end 114. Further, the circulating may be further based on the decelerating of the airflow.

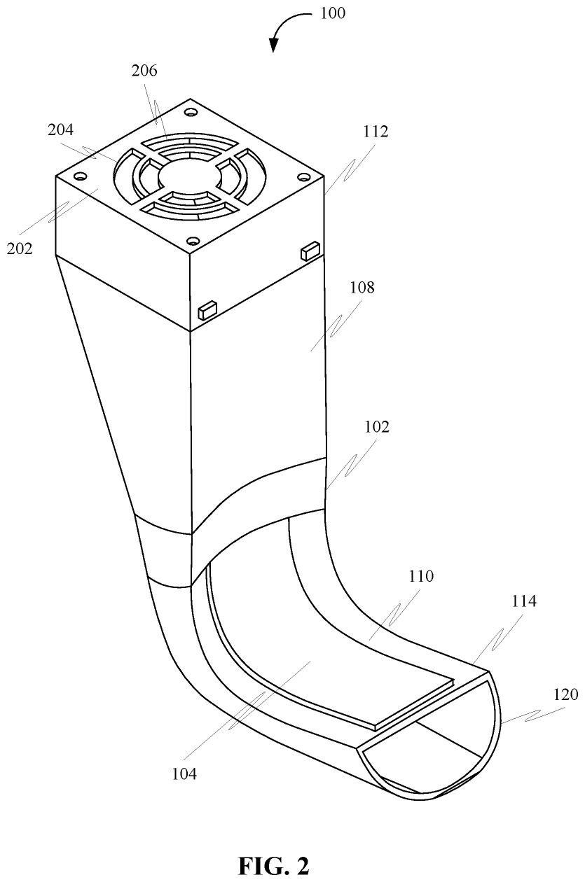

In further embodiments, the apparatus 100 may include a cover 202, as shown in FIG. 2, coupled with the first opening 118. Further, the cover 202 may include at least one opening 204-206 of at least one size. Further, the cover 202 may be configured for preventing at least one contaminant of the at least one size from entering the interior cavity through the first opening 118. Further, the at least one contaminant may include particulate, dust, paper chunks, etc.

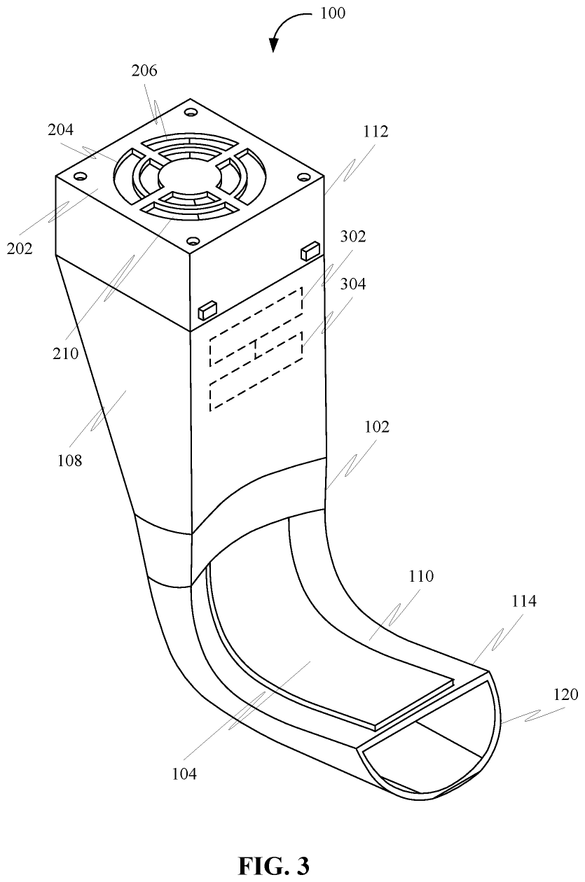

In further embodiments, the apparatus 100 may include at least one internal sensor 302 and a processing device 304, as shown in FIG. 3. Further, the at least one internal sensor 302 may be disposed on the elongated body 102. Further, the at least one internal sensor 302 may be configured for generating at least one internal data based on detecting at least one of an internal humidity, an internal temperature, and an internal pressure associated with the head worn apparatus. Further, the processing device 304 may be disposed on the elongated body 102. Further, the processing device 304 may be communicatively coupled with the at least one internal sensor 302. Further, the processing device 304 may be configured for analyzing the at least one internal data. Further, the processing device 304 may be configured for determining a fogging condition in the head worn apparatus based on the analyzing of the at least one internal data. Further, the processing device 304 may be configured for generating a command for the at least one fan assembly 106 based on the determining of the fogging condition. Further, the at least one fan assembly 106 may be communicatively coupled with the processing device 304. Further, the circulating of the airflow may be further based on the command.

Further, in an embodiment, the analyzing of the at least one internal data may include analyzing the at least one internal data using at least one machine learning model. Further, the at least one machine learning model may be configured for predicting a condition associated with the head worn apparatus. Further, the determining of the fogging condition may be further based on the predicting.

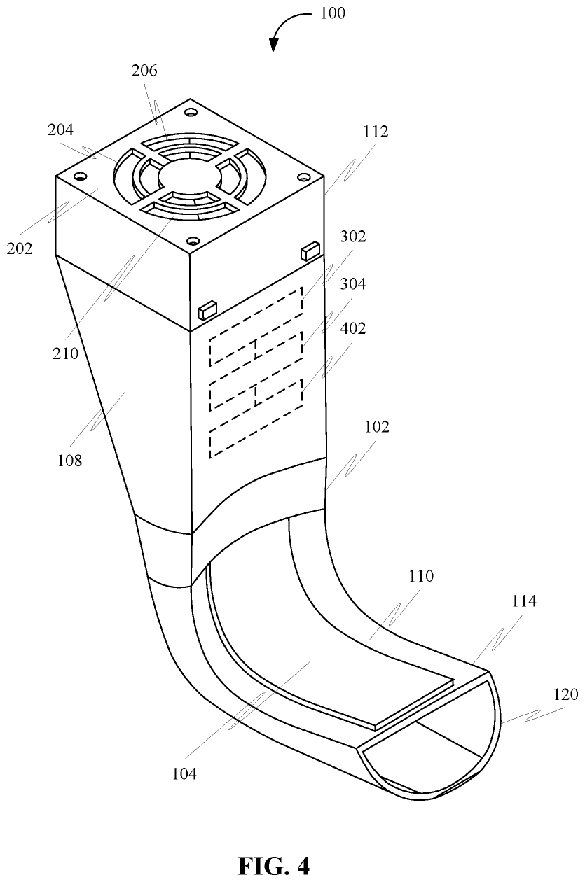

In further embodiments, the apparatus 100 may include a temperature control device 402, as shown in FIG. 4, disposed on the elongated body 102. Further, the temperature control device 402 may include a heating element and a cooling element disposed in the interior space 116. Further, the temperature control device 402 may be configured for controlling a temperature of the airflow. Further, the processing device 304 may be communicatively coupled with the temperature control device 402. Further, the processing device 304 may be further configured for generating a first command for the temperature control device 402 based on the determining of the fogging condition. Further, the temperature control device 402 may be configured for at least one of increasing and decreasing the temperature of the airflow based on the first command. Further, the preventing of the fogging in the head worn apparatus may be further based on at least one of the increasing and the decreasing the temperature of the airflow.

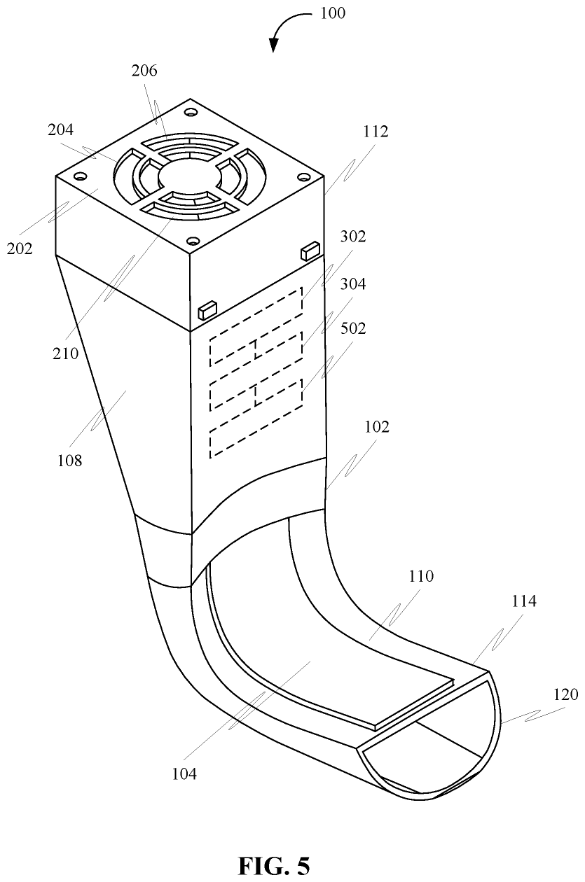

In further embodiments, the apparatus 100 may include a pressure control device 502, as shown in FIG. 5, disposed on the elongated body 102. Further, the pressure control device 502 may include an actuated pressure valve. Further, the pressure control device 502 may be configured for controlling a pressure in the interior space 116. Further, the processing device 304 may be communicatively coupled with the pressure control device 502. Further, the processing device 304 may be further configured for generating a second command for the pressure control device 502 based on the determining of the fogging condition. Further, the pressure control device 502 may be configured for at least one of increasing and decreasing the pressure in the interior space 116 based on the second command. Further, the preventing of the fogging in the head worn apparatus may be further based on at least one of the increasing and the decreasing the pressure in the interior space 116.

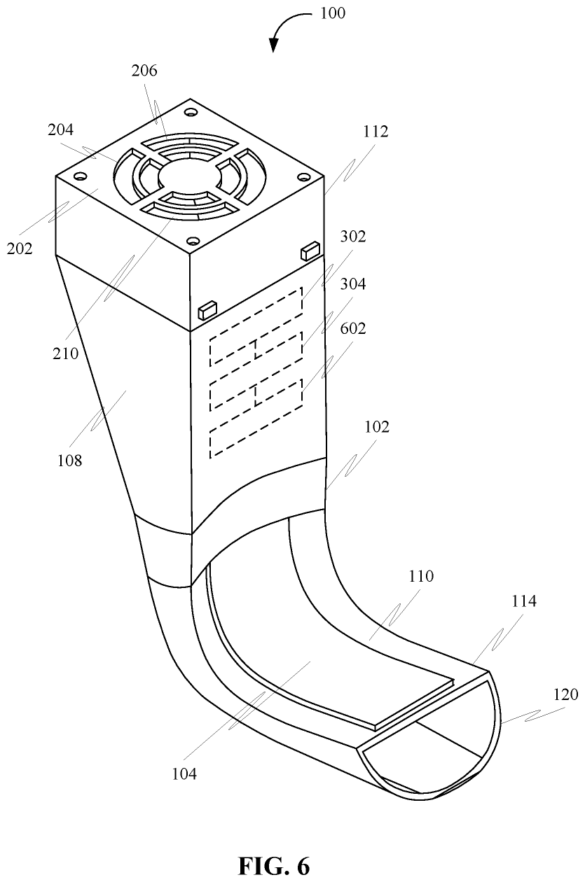

In further embodiments, the apparatus 100 may include a humidity control device 602, as shown in FIG. 6, disposed on the elongated body 102. Further, the humidity control device 602 may include an actuated dehumidifying element. Further, the humidity control device 602 may be configured for controlling a humidity associated with the airflow. Further, the controlling of the humidity associated with the airflow may include absorbing and introducing moisture in the airflow. Further, the processing device 304 may be communicatively coupled with the humidity control device 602. Further, the processing device 304 may be further configured for generating a third command for the humidity control device 602 based on the determining of the fogging condition. Further, the humidity control device 602 may be configured for at least one of increasing and decreasing the humidity of the airflow based on the third command. Further, the preventing of the fogging in the head worn apparatus may be further based on at least one of the increasing and the decreasing the humidity of the airflow.

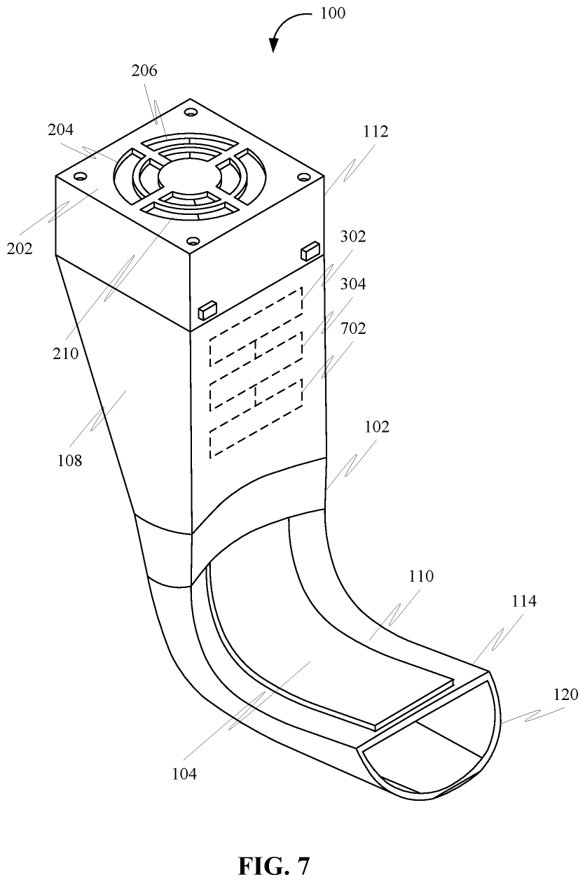

In further embodiments, the apparatus 100 may include a fan control device 702, as shown in FIG. 7, disposed on the elongated body 102. Further, the fan control device 702 may be configured for controlling a speed of the airflow. Further, the processing device 304 may be communicatively coupled with the fan control device 702. Further, the processing device 304 may be further configured for generating a fourth command for the fan control device 702 based on the determining of the fogging condition. Further, the fan control device 702 may be configured for at least one of increasing and decreasing a rotational speed of the at least one fan assembly 106 for at least one of increasing and decreasing the speed of the airflow based on the fourth command. Further, the preventing of the fogging in the head worn apparatus may be further based on at least one of the increasing and the decreasing the speed of the airflow.

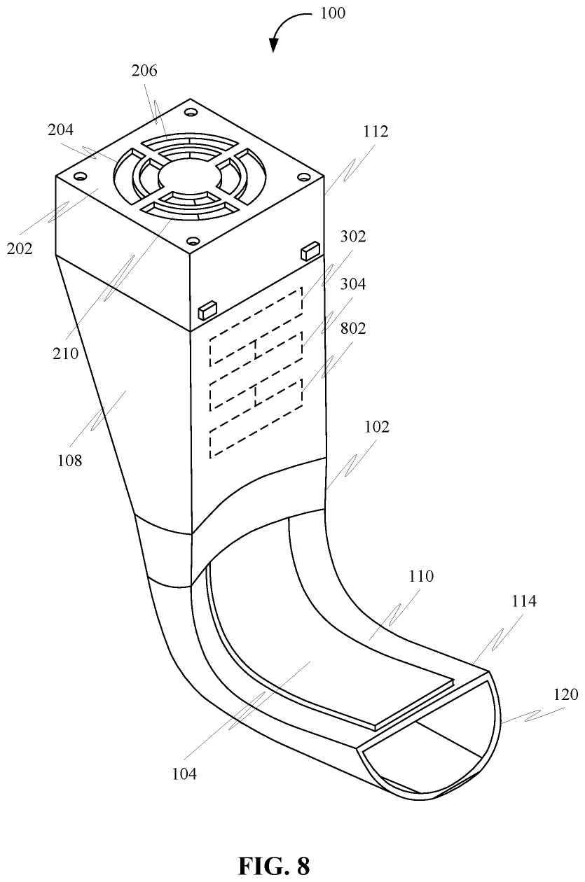

In further embodiments, the apparatus 100 may include an air volume control device 802, as shown in FIG. 8, disposed on the elongated body 102. Further, the air volume control device 802 may include an actuated lid. Further, the air volume control device 802 may be configured for controlling a volume of the airflow. Further, the actuated lid covers at least one portion of the first opening for the controlling of the volume of the airflow. Further, the processing device 304 may be communicatively coupled with the air volume control device 802. Further, the processing device 304 may be further configured for generating a fifth command for the air volume control device 802 based on the determining of the fogging condition. Further, the air volume control device 802 may be configured for at least one of increasing and decreasing the volume of the airflow based on the fifth command. Further, the preventing of the fogging in the head worn apparatus may be further based on at least one of the increasing and the decreasing the volume of the airflow.

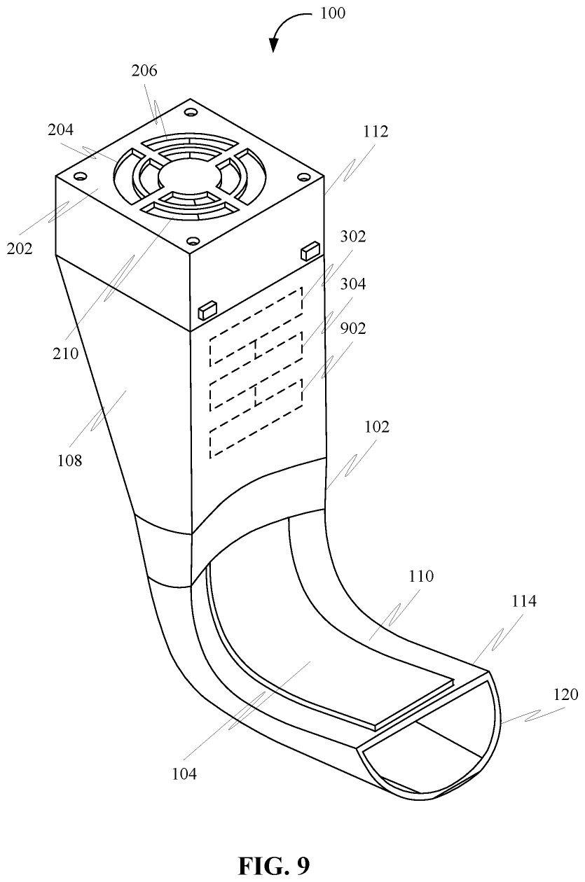

In further embodiments, the apparatus 100 may include at least one external sensor 902, as shown in FIG. 9, disposed on the elongated body 102. Further, the at least one external sensor 902 may be configured for generating at least one external data based on detecting at least one of an external humidity, an external temperature, and an external pressure associated an environment of the head worn apparatus. Further, the processing device 304 may be communicatively coupled with the at least one external sensor 902. Further, the processing device 304 may be configured for analyzing the at least one external data. Further, the determining of the fogging condition may be further based on the analyzing of the at least one external data.

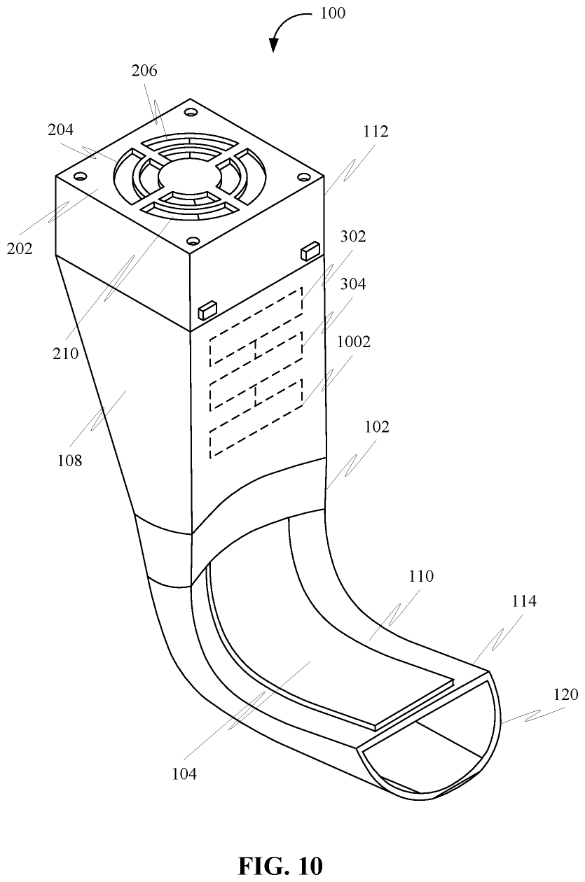

In further embodiments, the apparatus 100 may include at least one biological sensor 1002, as shown in FIG. 10, disposed on the elongated body 102. Further, the at least one biological sensor 1002 may be configured for generating at least one biological data associated with the user based on detecting at least one biological metric associated with the user. Further, the at least one biological metric may include a body temperature, a respiration rate, a perspiration rate, a heart rate, etc. Further, the processing device 304 may be communicatively coupled with the at least one biological sensor 1002. Further, the processing device 304 may be further configured for analyzing the at least one biological data. Further, the determining of the fogging condition may be further based on the analyzing of the at least one biological data.

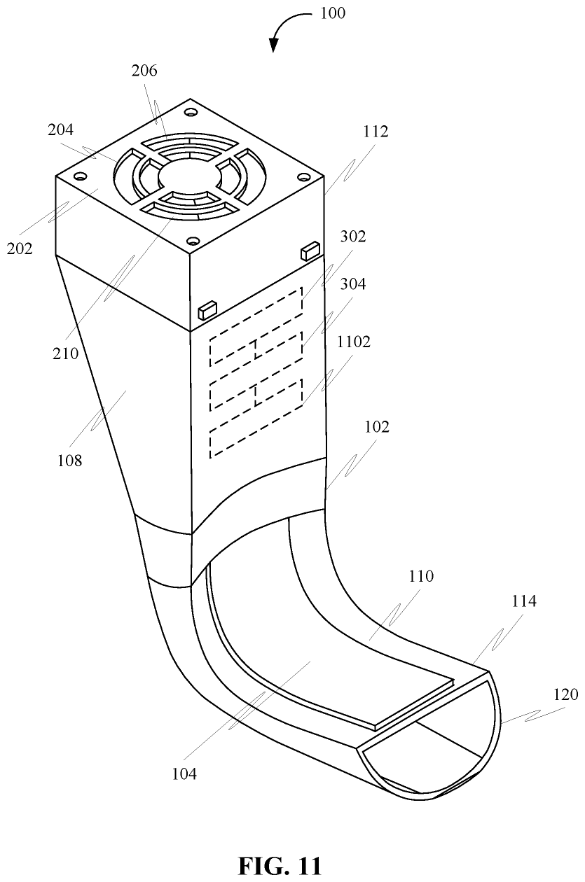

In further embodiments, the apparatus 100 may include at least one motion sensor 1102, as shown in FIG. 11, disposed on the elongated body 102. Further, the at least one motion sensor 1102 may be configured for generating at least one motion data associated with the user based on detecting at least one movement associated with the user. Further, the processing device 304 may be communicatively coupled with the at least one motion sensor 1102. Further, the processing device 304 may be further configured for analyzing the at least one motion data. Further, the determining of the fogging condition may be further based on the analyzing of the at least one motion data.

FIG. 2 is a side perspective of the apparatus 100 with the cover 202 for preventing the fogging in the head worn apparatus, in accordance with some embodiments.

FIG. 3 is a side perspective of the apparatus 100 with the cover 202 for preventing the fogging in the head worn apparatus, in accordance with some embodiments.

FIG. 4 is a side perspective of the apparatus 100 with the cover 202 for preventing the fogging in the head worn apparatus, in accordance with some embodiments.

FIG. 5 is a side perspective of the apparatus 100 with the cover 202 for preventing the fogging in the head worn apparatus, in accordance with some embodiments.

FIG. 6 is a side perspective of the apparatus 100 with the cover 202 for preventing the fogging in the head worn apparatus, in accordance with some embodiments.

FIG. 7 is a side perspective of the apparatus 100 with the cover 202 for preventing the fogging in the head worn apparatus, in accordance with some embodiments.

FIG. 8 is a side perspective of the apparatus 100 with the cover 202 for preventing the fogging in the head worn apparatus, in accordance with some embodiments.

FIG. 9 is a side perspective of the apparatus 100 with the cover 202 for preventing the fogging in the head worn apparatus, in accordance with some embodiments.

FIG. 10 is a side perspective of the apparatus 100 with the cover 202 for preventing the fogging in the head worn apparatus, in accordance with some embodiments.

FIG. 11 is a side perspective of the apparatus 100 with the cover 202 for preventing the fogging in the head worn apparatus, in accordance with some embodiments.

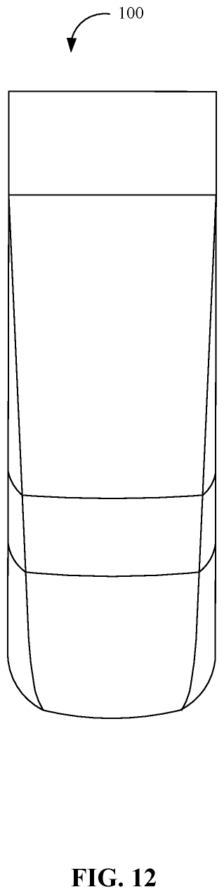

FIG. 12 is a front view of the apparatus 100 with the cover 202 for preventing the fogging in the head worn apparatus, in accordance with some embodiments.

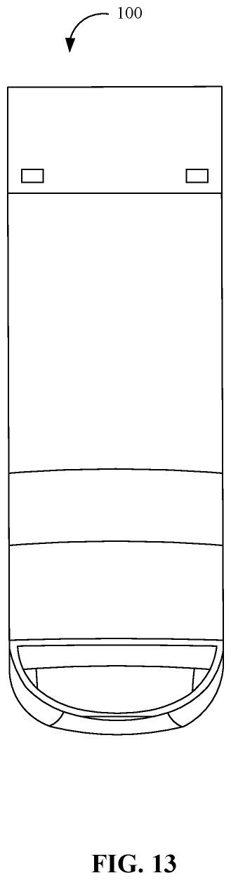

FIG. 13 is a rear view of the apparatus 100 with the cover 202 for preventing the fogging in the head worn apparatus, in accordance with some embodiments.

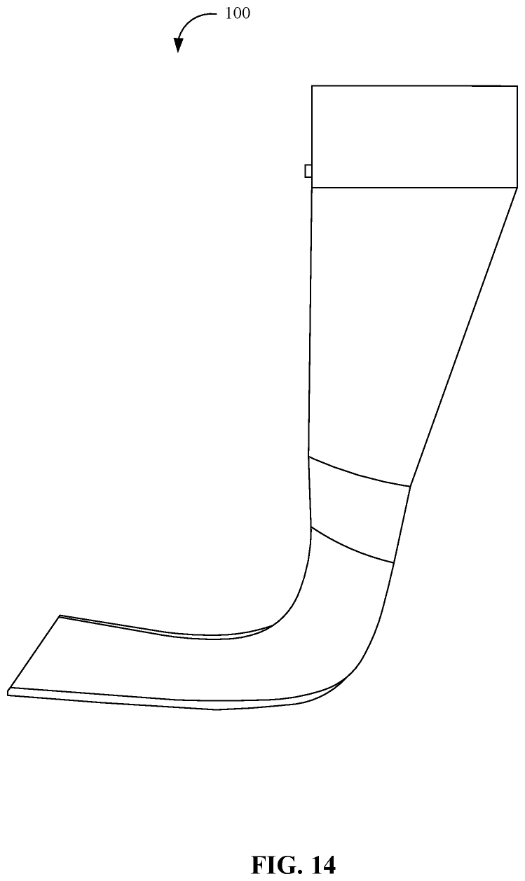

FIG. 14 is a right-side view of the apparatus 100 with the cover 202 for preventing the fogging in the head worn apparatus, in accordance with some embodiments.

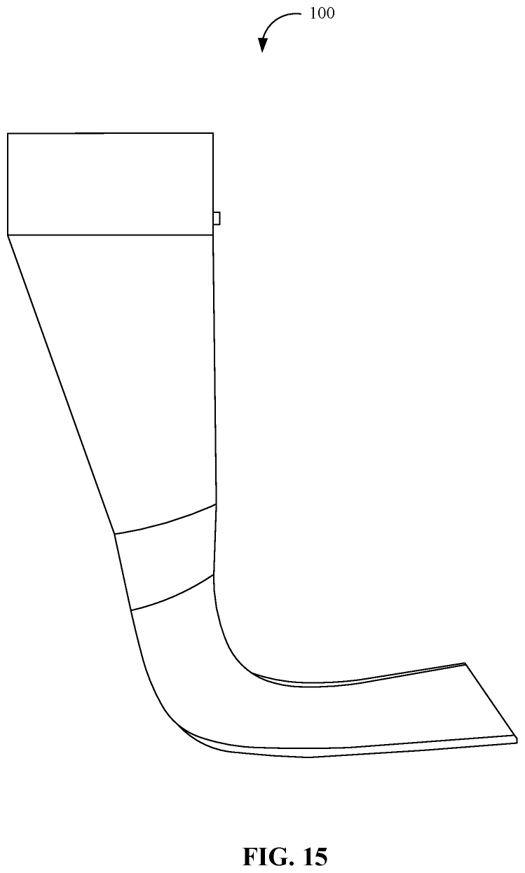

FIG. 15 is a left-side view of the apparatus 100 with the cover 202 for preventing the fogging in the head worn apparatus, in accordance with some embodiments.

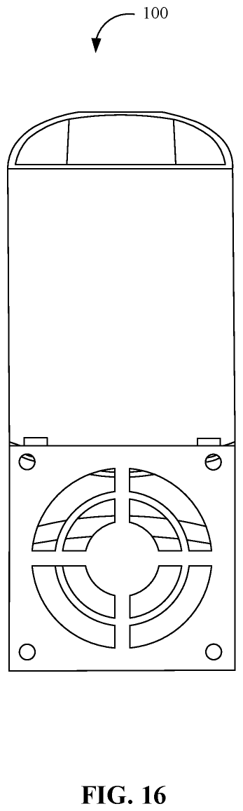

FIG. 16 is a top view of the apparatus 100 with the cover 202 for preventing the fogging in the head worn apparatus, in accordance with some embodiments.

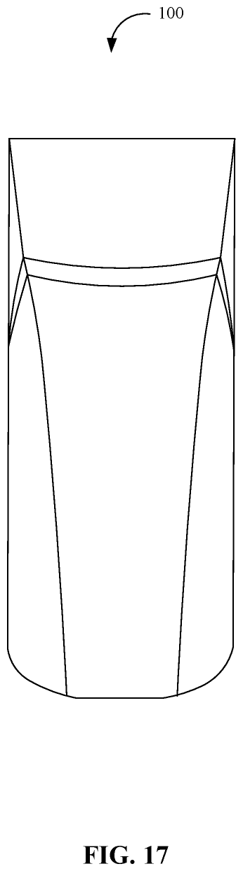

FIG. 17 is a bottom view of the apparatus 100 with the cover 202 for preventing the fogging in the head worn apparatus, in accordance with some embodiments.

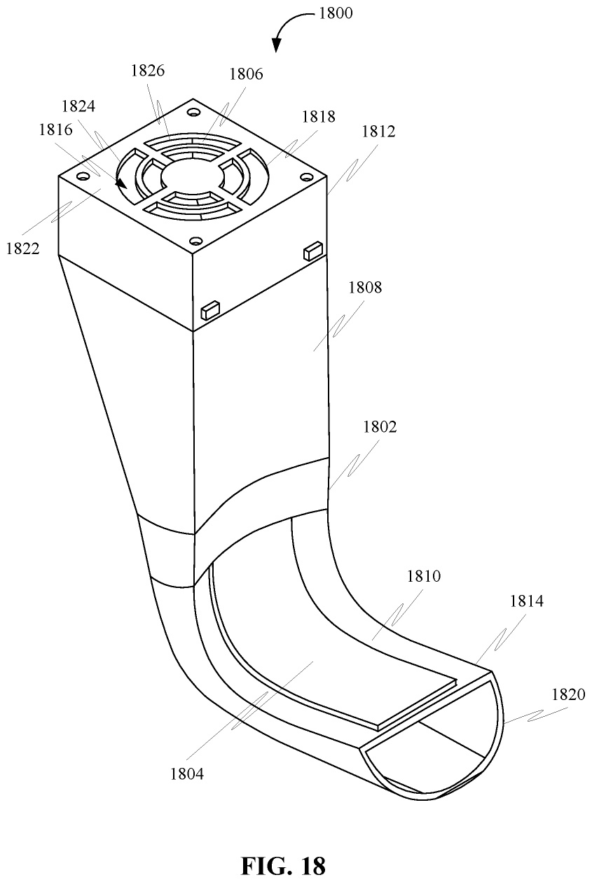

FIG. 18 is a side perspective of an apparatus 1800 for preventing fogging in a head worn apparatus, in accordance with some embodiments. Further, the head worn apparatus covers at least one portion of a head of a user. Further, the apparatus 1800 may include an elongated body 1802, at least one attachment mechanism 1804, at least one fan assembly 1806, and a cover 1822. Further, the elongated body 1802 may include a first portion 1808 and a second portion 1810. Further, the elongated body 1802 extends from a first end 1812 of the first portion 1808 to a second end 1814 of the second portion 1810. Further, the elongated body 1802 may be curved around an axis perpendicular to the elongated body 1802 making the first portion 1808 substantially perpendicular to the second portion 1810. Further, the elongated body 1802 may include an interior space 1816 and a first opening 1818 and a second opening 1820 leading into the interior space 1816. Further, the interior space 1816 extends between the first end 1812 and the second end 1814. Further, a cross sectional area of the first opening 1818 disposed on the first portion 1808 corresponds to a cross sectional area of the interior space 1816 at the first end 1812 and a cross sectional area of the second opening 1820 disposed on the second portion 1810 corresponds to the cross sectional area of the interior space 1816 at the second end 1814. Further, the elongated body 1802 tapers from the first end 1812 towards the second end 1814 reducing the cross sectional area of the interior space 1816 from the first end 1812 towards the second end 1814. Further, the at least one attachment mechanism 1804 may be disposed on the second portion 1810 of the elongated body 1802 proximal to the second opening 1820. Further, the at least one attachment mechanism 1804 may be configured to be coupled with at least one portion of the head worn apparatus for securing the apparatus 1800 to the head worn apparatus. Further, the interior space 1816 may be fluidly coupled with the head worn apparatus through the second opening 1820 based on the securing of the apparatus 1800 to the head worn apparatus. Further, the at least one fan assembly 1806 may be disposed in the interior cavity. Further, the at least one fan assembly 1806 may be coupled with the first opening 1818. Further, the at least one fan assembly 1806 may be electrically powered. Further, the at least one fan assembly 1806 may be configured for circulating airflow in the head worn apparatus. Further, the preventing of the fogging in the head worn apparatus may be based on the circulating of the airflow. Further, the cover 1822 may be coupled with the first opening 1818. Further, the cover 1822 may include at least one opening 1824-1826 of at least one size. Further, the cover 1822 may be configured for preventing at least one contaminant of the at least one size from entering the interior cavity through the first opening 1818.

Further, in some embodiments, the at least one fan assembly 1806 may be configured for drawing the airflow into the interior space 1816 through the first opening 1818 and expelling the airflow to the head worn apparatus through the second opening 1820. Further, the circulating may be based on the drawing of the airflow through the first opening 1818 and the expelling of the airflow through the second opening 1820.

Further, in an embodiment, the elongated body 1802 may be configured for accelerating the airflow in the interior space 1816 based on the reducing of the cross sectional area of the interior space 1816 from the first end 1812 towards the second end 1814. Further, the circulating may be further based on the accelerating of the airflow.

Further, in some embodiments, the at least one fan assembly 1806 may be configured for drawing the airflow into the interior space 1816 from the head worn apparatus through the second opening 1820 and expelling the airflow through the first opening 1818. Further, the circulating may be based on the drawing of the airflow through the second opening 1820 and the expelling of the airflow through the first opening 1818.

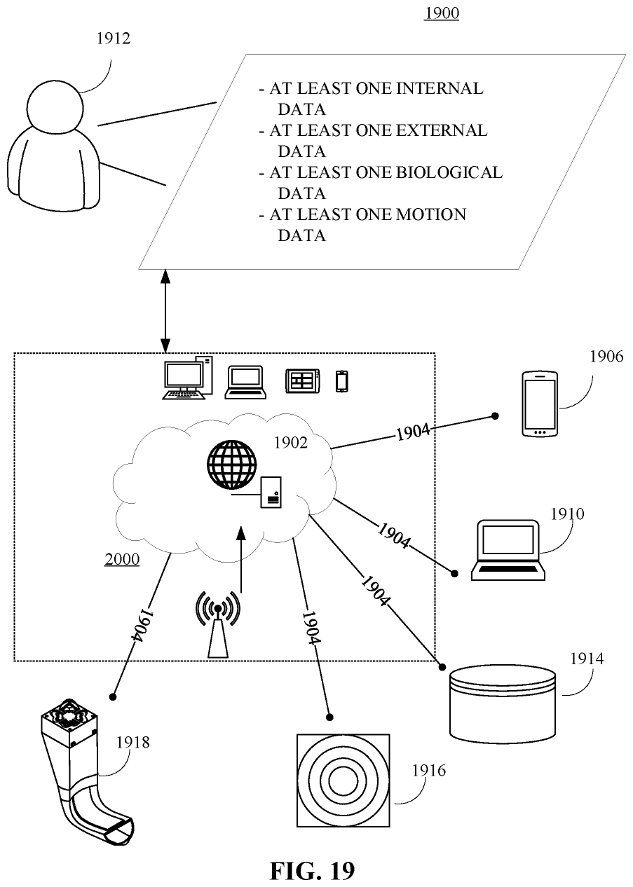

FIG. 19 is an illustration of an online platform 1900 consistent with various embodiments of the present disclosure. By way of non-limiting example, the online platform 1900 to facilitate preventing fogging in a head worn apparatus may be hosted on a centralized server 1902, such as, for example, a cloud computing service. The centralized server 1902 may communicate with other network entities, such as, for example, a mobile device 1906 (such as a smartphone, a laptop, a tablet computer etc.), other electronic devices 1910 (such as desktop computers, server computers etc.), databases 1914, sensors 1916, and an apparatus 1918 (such as the apparatus 100, the apparatus 1800, etc.) over a communication network 1904, such as, but not limited to, the Internet. Further, users of the online platform 1900 may include relevant parties such as, but not limited to, end-users, administrators, service providers, service consumers and so on. Accordingly, in some instances, electronic devices operated by the one or more relevant parties may be in communication with the platform.

A user 1912, such as the one or more relevant parties, may access online platform 1900 through a web based software application or browser. The web based software application may be embodied as, for example, but not be limited to, a website, a web application, a desktop application, and a mobile application compatible with a computing device 2000.

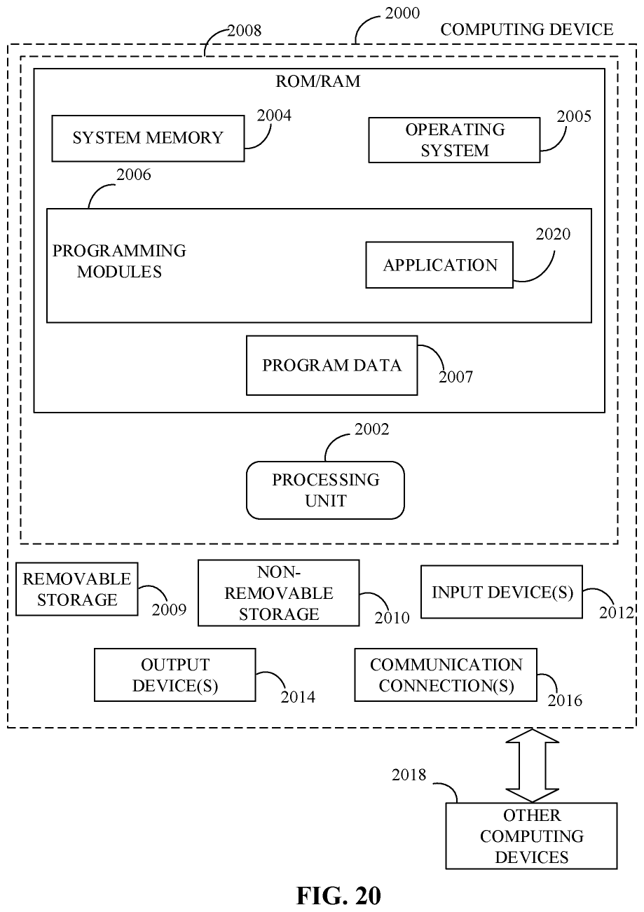

With reference to FIG. 20, a system consistent with an embodiment of the disclosure may include a computing device or cloud service, such as computing device 2000. In a basic configuration, computing device 2000 may include at least one processing unit 2002 and a system memory 2004. Depending on the configuration and type of computing device, system memory 2004 may comprise, but is not limited to, volatile (e.g. random-access memory (RAM)), non-volatile (e.g. read-only memory (ROM)), flash memory, or any combination. System memory 2004 may include operating system 2005, one or more programming modules 2006, and may include a program data 2007. Operating system 2005, for example, may be suitable for controlling computing device 2000′s operation. In one embodiment, programming modules 2006 may include machine learning module. Furthermore, embodiments of the disclosure may be practiced in conjunction with a graphics library, other operating systems, or any other application program and is not limited to any particular application or system. This basic configuration is illustrated in FIG. 20 by those components within a dashed line 2008.

Computing device 2000 may have additional features or functionality. For example, computing device 2000 may also include additional data storage devices (removable and/or non-removable) such as, for example, magnetic disks, optical disks, or tape. Such additional storage is illustrated in FIG. 20 by a removable storage 2009 and a non-removable storage 2010. Computer storage media may include volatile and non-volatile, removable and non-removable media implemented in any method or technology for storage of information, such as computer-readable instructions, data structures, program modules, or other data. System memory 2004, removable storage 2009, and non-removable storage 2010 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 2000. Any such computer storage media may be part of device 2000. Computing device 2000 may also have input device(s) 2012 such as a keyboard, a mouse, a pen, a sound input device, a touch input device, a location sensor, a camera, a biometric sensor, etc. Output device(s) 2014 such as a display, speakers, a printer, etc. may also be included. The aforementioned devices are examples and others may be used.

Computing device 2000 may also contain a communication connection 2016 that may allow device 2000 to communicate with other computing devices 2018, such as over a network in a distributed computing environment, for example, an intranet or the Internet. Communication connection 2016 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 2004, including operating system 2005. While executing on processing unit 2002, programming modules 2006 may perform processes including, for example, one or more stages of methods, algorithms, systems, applications, servers, databases as described above. The aforementioned process is an example, and processing unit 2002 may perform other processes. Other programming modules that may be used in accordance with embodiments of the present disclosure may include machine learning applications.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, general purpose graphics processor-based systems, multiprocessor systems, microprocessor-based or programmable consumer electronics, application specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

Although the present disclosure has been explained in relation to its preferred embodiment, it is to be understood that many other possible modifications and variations can be made without departing from the spirit and scope of the disclosure.

What is claimed is:

1. An apparatus for preventing fogging in a head worn apparatus, wherein the head worn apparatus covers at least one portion of a head of a user, wherein the apparatus comprises:
an elongated body comprising a first portion and a second portion, wherein the elongated body extends from a first end of the first portion to a second end of the second portion, wherein the elongated body is curved around an axis perpendicular to the elongated body making the first portion substantially perpendicular to the second portion, wherein the elongated body comprises an interior space and a first opening and a second opening leading into the interior space, wherein the interior space extends between the first end and the second end, wherein a cross sectional area of the first opening disposed on the first portion corresponds to a cross sectional area of the interior space at the first end and a cross sectional area of the second opening disposed on the second portion corresponds to the cross sectional area of the interior space at the second end, wherein the elongated body tapers from the first end towards the second end reducing the cross sectional area of the interior space from the first end towards the second end;
at least one attachment mechanism disposed on the second portion of the elongated body proximal to the second opening, wherein the at least one attachment mechanism is configured to be coupled with at least one portion of the head worn apparatus for securing the apparatus to the head worn apparatus, wherein the interior space is fluidly coupled with the head worn apparatus through the second opening based on the securing of the apparatus to the head worn apparatus; and
at least one fan assembly disposed in the interior cavity, wherein the at least one fan assembly is coupled with the first opening, wherein the at least one fan assembly is electrically powered, wherein the at least one fan assembly is configured for circulating airflow in the head worn apparatus, wherein the preventing of the fogging in the head worn apparatus is based on the circulating of the airflow.

2. The apparatus of claim 1, wherein the at least one fan assembly is configured for drawing the airflow into the interior space through the first opening and expelling the airflow to the head worn apparatus through the second opening, wherein the circulating is based on the drawing of the airflow through the first opening and the expelling of the airflow through the second opening.

3. The apparatus of claim 2, wherein the elongated body is configured for accelerating the airflow in the interior space based on the reducing of the cross sectional area of the interior space from the first end towards the second end, wherein the circulating is further based on the accelerating of the airflow.

4. The apparatus of claim 1, wherein the at least one fan assembly is configured for drawing the airflow into the interior space from the head worn apparatus through the second opening and expelling the airflow through the first opening, wherein the circulating is based on the drawing of the airflow through the second opening and the expelling of the airflow through the first opening.

5. The apparatus of claim 5, wherein the elongated body is configured for decelerating the airflow in the interior space based on the reducing of the cross sectional area of the interior space from the first end towards the second end, wherein the circulating is further based on the decelerating of the airflow.

6. The apparatus of claim 1 further comprising a cover coupled with the first opening, wherein the cover comprises at least one opening of at least one size, wherein the cover is configured for preventing at least one contaminant of the at least one size from entering the interior cavity through the first opening.

7. The apparatus of claim 1 further comprising:
at least one internal sensor disposed on the elongated body, wherein the at least one internal sensor is configured for generating at least one internal data based on detecting at least one of an internal humidity, an internal temperature, and an internal pressure associated with the head worn apparatus;
a processing device disposed on the elongated body, wherein the processing device is communicatively coupled with the at least one internal sensor, wherein the processing device is configured for:
analyzing the at least one internal data;
determining a fogging condition in the head worn apparatus based on the analyzing of the at least one internal data; and
generating a command for the at least one fan assembly based on the determining of the fogging condition, wherein the at least one fan assembly is communicatively coupled with the processing device, wherein the circulating of the airflow is further based on the command.

8. The apparatus of claim 7, wherein the analyzing of the at least one internal data comprises analyzing the at least one internal data using at least one machine learning model, wherein the at least one machine learning model is configured for predicting a condition associated with the head worn apparatus, wherein the determining of the fogging condition is further based on the predicting.

9. The apparatus of claim 7 further comprising a temperature control device disposed on the elongated body, wherein the temperature control device is configured for controlling a temperature of the airflow, wherein the processing device is communicatively coupled with the temperature control device, wherein the processing device is further configured for generating a first command for the temperature control device based on the determining of the fogging condition, wherein the temperature control device is configured for at least one of increasing and decreasing the temperature of the airflow based on the first command, wherein the preventing of the fogging in the head worn apparatus is further based on at least one of the increasing and the decreasing the temperature of the airflow.

10. The apparatus of claim 7 further comprising a pressure control device disposed on the elongated body, wherein the pressure control device is configured for controlling a pressure in the interior space, wherein the processing device is communicatively coupled with the pressure control device, wherein the processing device is further configured for generating a second command for the pressure control device based on the determining of the fogging condition, wherein the pressure control device is configured for at least one of increasing and decreasing the pressure in the interior space based on the second command, wherein the preventing of the fogging in the head worn apparatus is further based on at least one of the increasing and the decreasing the pressure in the interior space.

11. The apparatus of claim 7 further comprising a humidity control device disposed on the elongated body, wherein the humidity control device is configured for controlling a humidity associated with the airflow, wherein the processing device is communicatively coupled with the humidity control device, wherein the processing device is further configured for generating a third command for the humidity control device based on the determining of the fogging condition, wherein the humidity control device is configured for at least one of increasing and decreasing the humidity of the airflow based on the third command, wherein the preventing of the fogging in the head worn apparatus is further based on at least one of the increasing and the decreasing the humidity of the airflow.

12. The apparatus of claim 7 further comprising a fan control device disposed on the elongated body, wherein the fan control device is configured for controlling a speed of the airflow, wherein the processing device is communicatively coupled with the fan control device, wherein the processing device is further configured for generating a fourth command for the fan control device based on the determining of the fogging condition, wherein the fan control device is configured for at least one of increasing and decreasing a rotational speed of the at least one fan assembly for at least one of increasing and decreasing the speed of the airflow based on the fourth command, wherein the preventing of the fogging in the head worn apparatus is further based on at least one of the increasing and the decreasing the speed of the airflow.

13. The apparatus of claim 7 further comprising an air volume control device disposed on the elongated body, wherein the air volume control device is configured for controlling a volume of the airflow, wherein the processing device is communicatively coupled with the air volume control device, wherein the processing device is further configured for generating a fifth command for the air volume control device based on the determining of the fogging condition, wherein the air volume control device is configured for at least one of increasing and decreasing the volume of the airflow based on the fifth command, wherein the preventing of the fogging in the head worn apparatus is further based on at least one of the increasing and the decreasing the volume of the airflow.

14. The apparatus of claim 7 further comprising at least one external sensor disposed on the elongated body, wherein the at least one external sensor is configured for generating at least one external data based on detecting at least one of an external humidity, an external temperature, and an external pressure associated an environment of the head worn apparatus, wherein the processing device is communicatively coupled with the at least one external sensor, wherein the processing device is configured for analyzing the at least one external data, wherein the determining of the fogging condition is further based on the analyzing of the at least one external data.

15. The apparatus of claim 7 further comprising at least one biological sensor disposed on the elongated body, wherein the at least one biological sensor is configured for generating at least one biological data associated with the user based on detecting at least one biological metric associated with the user, wherein the processing device is communicatively coupled with the at least one biological sensor, wherein the processing device is further configured for analyzing the at least one biological data, wherein the determining of the fogging condition is further based on the analyzing of the at least one biological data.

16. The apparatus of claim 7 further comprising at least one motion sensor disposed on the elongated body, wherein the at least one motion sensor is configured for generating at least one motion data associated with the user based on detecting at least one movement associated with the user, wherein the processing device is communicatively coupled with the at least one motion sensor, wherein the processing device is further configured for analyzing the at least one motion data, wherein the determining of the fogging condition is further based on the analyzing of the at least one motion data.

17. An apparatus for preventing fogging in a head worn apparatus, wherein the head worn apparatus covers at least one portion of a head of a user, wherein the apparatus comprises:
an elongated body comprising a first portion and a second portion, wherein the elongated body extends from a first end of the first portion to a second end of the second portion, wherein the elongated body is curved around an axis perpendicular to the elongated body making the first portion substantially perpendicular to the second portion, wherein the elongated body comprises an interior space and a first opening and a second opening leading into the interior space, wherein the interior space extends between the first end and the second end, wherein a cross sectional area of the first opening disposed on the first portion corresponds to a cross sectional area of the interior space at the first end and a cross sectional area of the second opening disposed on the second portion corresponds to the cross sectional area of the interior space at the second end, wherein the elongated body tapers from the first end towards the second end reducing the cross sectional area of the interior space from the first end towards the second end;
at least one attachment mechanism disposed on the second portion of the elongated body proximal to the second opening, wherein the at least one attachment mechanism is configured to be coupled with at least one portion of the head worn apparatus for securing the apparatus to the head worn apparatus, wherein the interior space is fluidly coupled with the head worn apparatus through the second opening based on the securing of the apparatus to the head worn apparatus;
at least one fan assembly disposed in the interior cavity, wherein the at least one fan assembly is coupled with the first opening, wherein the at least one fan assembly is electrically powered, wherein the at least one fan assembly is configured for circulating airflow in the head worn apparatus, wherein the preventing of the fogging in the head worn apparatus is based on the circulating of the airflow; and
a cover coupled with the first opening, wherein the cover comprises at least one opening of at least one size, wherein the cover is configured for preventing at least one contaminant of the at least one size from entering the interior cavity through the first opening.

18. The apparatus of claim 17, wherein the at least one fan assembly is configured for drawing the airflow into the interior space through the first opening and expelling the airflow to the head worn apparatus through the second opening, wherein the circulating is based on the drawing of the airflow through the first opening and the expelling of the airflow through the second opening.

19. The apparatus of claim 18, wherein the elongated body is configured for accelerating the airflow in the interior space based on the reducing of the cross sectional area of the interior space from the first end towards the second end, wherein the circulating is further based on the accelerating of the airflow.

20. The apparatus of claim 17, wherein the at least one fan assembly is configured for drawing the airflow into the interior space from the head worn apparatus through the second opening and expelling the airflow through the first opening, wherein the circulating is based on the drawing of the airflow through the second opening and the expelling of the airflow through the first opening.
